(19) United States
(12) Patent Application Publication
(10) Pub. No.: US 2017/0308866 A1
(43) Pub. Date: Oct. 26, 2017

(54) Meeting Scheduling Resource Efficiency

(71) Applicant: MICROSOFT TECHNOLOGY LICENSING, LLC, Redmond, WA (US)

(72) Inventors: Dikla Dotan-Cohen, Herzliya (IL); Adi Miller, Tel Aviv (IL); Haim Somech, Ramat Gan (IL); Oded Nahir, Herzliya (IL)

(21) Appl. No.: 15/136,457

(22) Filed: Apr. 22, 2016

(51) Int. Cl. G06Q 10/10; H04L 12/26

(52) U.S. Cl. CPC G06Q 10/1095; H04L 43/0876

(57) ABSTRACT

Meeting scheduling resources are provided including systems and methods for optimizing proposed meeting details using historical information derived from meeting invitees. A statistical analysis, which may employ machine-learning techniques, may be used to determine a meeting attendance model based on past meetings and/or events, user activity, or other information associated with a user. Meeting patterns and availability for the user also may be used to generate the meeting attendance model. A meeting manager service may implement the meeting attendance models to facilitate schedule future meetings. The meeting manager service may also determine an attendance importance for invitees, a likelihood of attending the proposed meeting, given specific meeting features of the proposed meeting (such as time, location, or other meeting features) and recommend optimal meeting features for the proposed meeting.

### BACKGROUND

A variety of computer implemented meeting and calendaring solutions are available to assist users in planning and organizing their schedules. Generally, such solutions allow meeting organizers to select invitees that will be included in a meeting invitation. In some cases, the meeting organizer has the ability to view the availability of invitees based on a calendar maintained by an invitee. However, when using a scheduling assistant, a potential invitee's availability status is typically only shown as free, busy, tentative, or out of office. Further, availability is typically limited to information that has been manually entered by a user. The meeting organizer typically sets the time, location and subject of the meeting prior to sending a meeting invitation to invitees, without advanced knowledge of whether the meeting details are acceptable for meeting invitees.

The inherent difficulties in scheduling meetings have been compounded by the increased connectivity provided by modern computing technology. For example, it is now commonplace for work to be performed remotely and outside of traditional working hours, which has resulted in fewer hours spent in the workplace. On the other hand, advances in computing technology and the prevalence of modern computing devices have resulted in a dramatic increase in data available for facilitating meetings. The current solutions have not kept pace with these advances and have failed to capitalize on the available data in order to address these new challenges.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate to systems and methods for facilitating meetings through employing a deep analysis of user profile activity and prior meeting information to generate meeting attendance models for use in creating optimal meeting details for a proposed meeting. Data elements, which may be nearly constantly generated by user computing devices (user devices), can be used to create knowledge and/or inferences relating to meeting attendance trends in order to build a meeting attendance model for a given user profile associated with the user devices. User devices may be associated with a particular user profile based on network related data, such as a network ID or connection data, an assignment of the user device to a particular user profile, application data, context data, calendar data, or nearly any other source of data that may be sensed and/or determined by a computing device.

In one embodiment, a meeting management system facilitates a deep analysis of meeting data elements or “features” within a data structure to generate a plurality of meeting attendance models. In one aspect, the system may generally operate to determine a meeting pattern from a plurality of meeting events. In some aspects, the system determines a set of meeting features associated with the plurality of meeting events. Additionally, the system may use a meeting pattern inference engine to determine a meeting pattern based on an analysis of the plurality of meeting events. The system may further operate to determine user availability for attending a future meeting over a range of time. Further, the system may be configured to generate a meeting attendance model for the user based at least on the determined meeting pattern and the determined user availability. In some aspects, the system may facilitate scheduling a future meeting based at least in part on the meeting attendance model.

In another embodiment, a system for determining optimal meeting features is disclosed. The system may include a meeting pattern inference engine configured to determine a meeting pattern from a plurality of meeting events. In some aspects, the system includes a meeting manager configured to determine optimal meeting features for future meetings.

Further, in some aspects, the system comprises one or more processors and one or more computer storage media storing computer-useable instructions that, when executed by the one or more processors, implement a method. In one aspect, the method comprises receiving a first set of meeting features for a proposed meeting. The method may also include determining one or more invitees from the features. In one aspect, the method comprises accessing a meeting attendance model for at least one invitee of the one or more invitees. Further, in some aspects, the method comprises determining a likelihood of attendance for the at least one invitee. Additionally, the method may comprise determining a second set of meeting features optimized according to the likelihood of attendance for the at least one invitee. Further, the method may also include generating a revised meeting invitation according to the second set of meeting features.

In an additional embodiment, a computerized method for facilitating a meeting event is disclosed. The method includes monitoring a set of user devices associated with one or more users to detect a meeting event. In one aspect, the method comprises determining a set of meeting features associated with the meeting event. Further, in some aspects, the method comprises determining a meeting pattern. Additionally, the method may comprise determining an availability of the one or more users for attending a future meeting over a range of time. Further, the method may also include generating a meeting attendance model for the one or more users based on the determined meeting pattern and the determined one or more users availability. The method may also include receiving a first set of meeting features for a proposed meeting and determining one or more invitees from the features. Further, in some aspects, the method comprises accessing a meeting attendance model for at least one invitee of the one or more invitees. Further, the method may also include determining a likelihood of attendance for the at least one invitee. The method may also include determining a second set of meeting features optimized according to the likelihood of attendance for the at least one invitee. Additionally, the method may comprise generating a revised meeting invitation according to the second set of meeting features.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram illustrating an exemplary meeting management system in which some embodiments of the present invention may be employed;

FIG. 3 is a diagram illustrating exemplary features which may be used by the meeting management system to generate meeting attendance models;

FIG. 4 is a flow diagram that illustrates a method for generating meeting attendance models to facilitate scheduling future meetings;

FIG. 5 is a flow diagram that illustrates a method for determining optimal meeting features for proposed meetings; and

FIG. 6 is a block diagram that illustrates an exemplary computing device.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

The coalescence of telecommunications and computing technologies in the modern era has enabled, for the first time in human history, nearly constant communication and access to job-related resources through a ubiquity of personal computing resources (including personal computing devices and cloud-computing coupled with communication networks). But at the same time, it is now commonplace for work to be done remotely and outside of traditional working hours. As a result, new computer technologies are emerging for tailoring computing services and information delivery to users, based on circumstances, or other information, that is specific to those users. Such personalization of computing services can provide information that is specifically relevant to a user, their individual schedule, and routines. One aspect of tailoring the personal computing experience to the user includes tailoring features of proposed meetings to increase a likelihood of attendance by those persons for which attendance is important. In some embodiments, a meeting attendance model may be determined from an analysis of data related to prior meetings, including data sensed by the computer technology, and used to infer meeting features for the future meetings.

By using meeting attendance models to predict meeting availability and attendance, computing and facilities resources may be saved. This is accomplished, in part, by reducing the number of emails and/or meeting invitations volleyed between meeting organizers and meeting invitees and the likelihood of needing to schedule additional meetings because important invitees did not attend. For example, an embodiment of the present disclosure allows a meeting organizer to assess likelihood of acceptance of a meeting or event invitation before the initial invitation is even sent. As a result, meeting invitation details may be optimized prior to sending the invitation. Additionally, in some embodiments, a plurality of meeting attendance models may be aggregated to provide optimal meeting details for a particular meeting with a large number of meeting invitees.

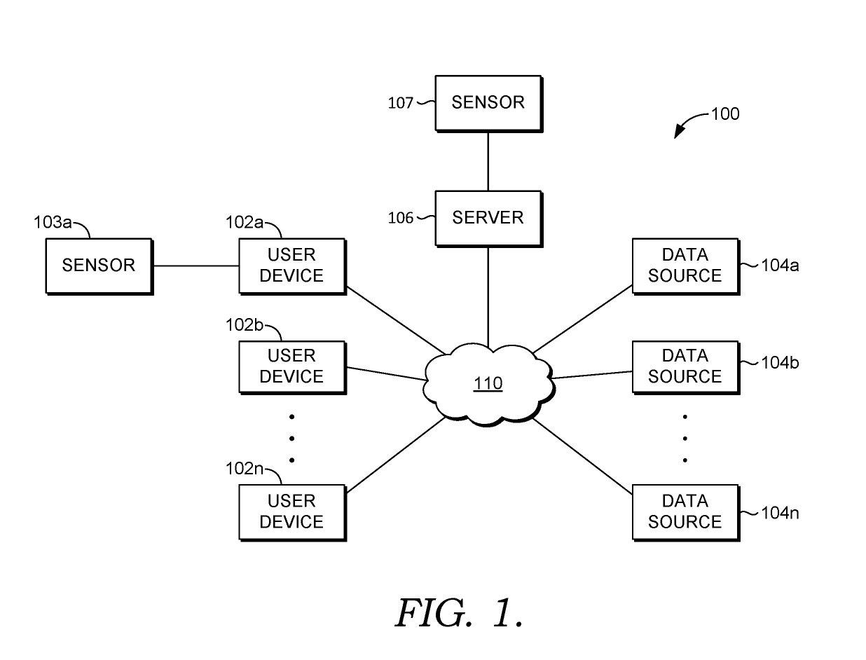

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

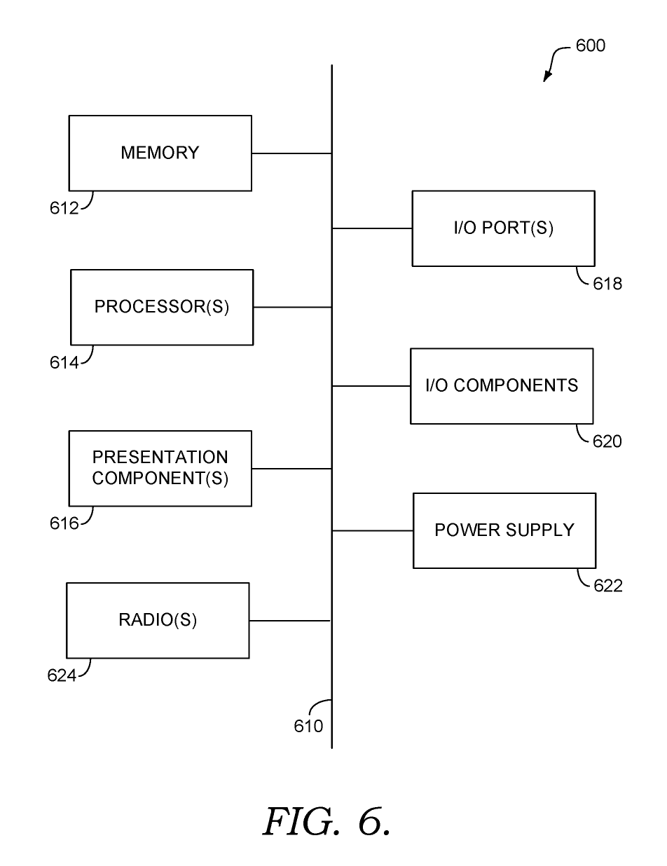

Among other components not shown, example operating environment 100 includes a number of user devices, such as user devices 102a and 102b through 102n; a number of data sources, such as data sources 104a and 104b through 104n; server 106; sensors 103a and 107, and network 110. It should be understood that environment 100 shown in FIG. 1 is an example of one suitable operating environment. Each of the components shown in FIG. 1 may be implemented via any type of computing device, such as computing device 600, described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 maybe provided via multiple devices arranged in a distributed environment that collectively provide the functionality described herein. Additionally, other components not shown may also be included within the distributed environment.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, a camera, remote control, a bar code scanner, a computerized measuring device, appliance, consumer electronic device, a workstation, or any combination of these delineated devices, or any other suitable device.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

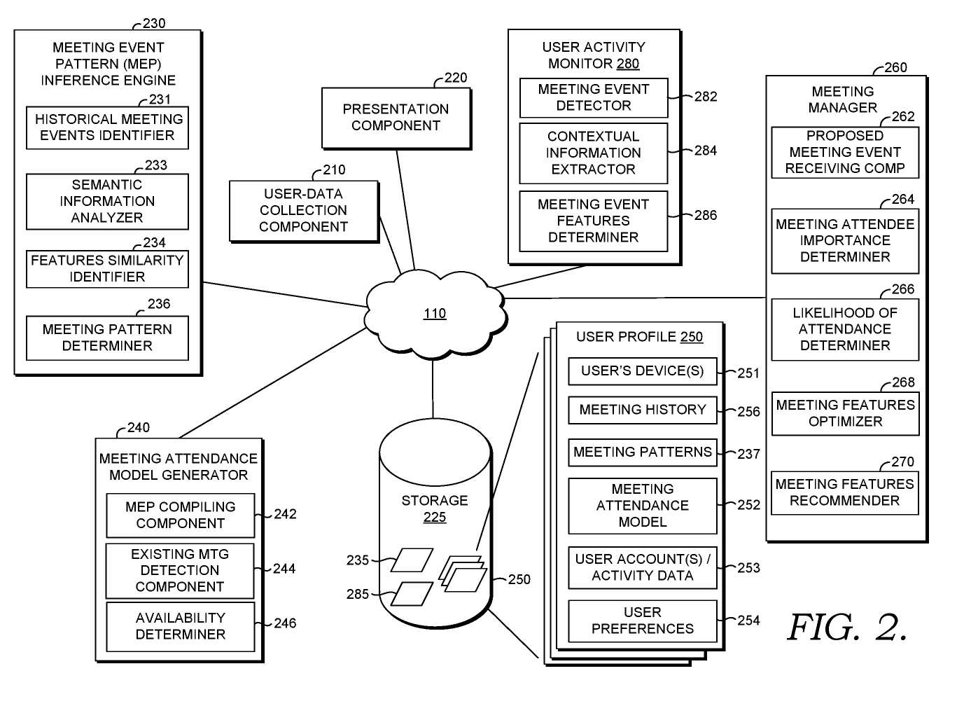

Data sources 104a and 104b through 104n may comprise data sources and/or data systems, which are configured to make data available to any of the various constituents of operating environment 100, or meeting management system 200 described in connection to FIG. 2. For instance, in one embodiment, one or more data sources 104a through 104n provide (or make available for accessing) data to user-data collection component 210 of FIG. 2. Data sources 104a and 104b through 104n may be discrete from user devices 102a and 102b through 102n and server 106 or may be incorporated and/or integrated into at least one of those components. In one embodiment, one or more of data sources 104a though 104n comprises one or more sensors, which may be integrated into or associated with one or more of the user device(s) 102a, 102b, or 102n or server 106. Examples of sensed meeting data made available by data sources 104a though 104n are described further in connection to user-data collection component 210 of FIG. 2.

Operating environment 100 can be utilized to implement one or more of the components of meeting management system 200, described in FIG. 2, including components for collecting user data, inferring meeting patterns, generating meeting attendance models, generating meeting event details or features, and/or presenting meeting event invitations and related content to users. Referring now to FIG. 2, with FIG. 1, a block diagram is provided showing aspects of an example computing system architecture suitable for implementing an embodiment of the invention and designated generally as meeting management system 200. The meeting management system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Turning now to FIG. 2, a block diagram is provided illustrating an exemplary meeting management system 200 in which some embodiments of the present disclosure may be employed. The meeting management system 200 includes network 110, which is described in connection to FIG. 1, and which communicatively couples components of meeting management system 200, including user -user-data collection component 210, presentation component 220, storage 225, meeting event pattern inference engine 230, meeting attendance model generator 240, user profile(s) 250, meeting manager 260, and user activity monitor 280. The components of meeting management system 200 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of system 200 are associated with one or more personal assistant applications, services, or routines. In particular, such applications, services, or routines may operate on one or more user devices (such as user device 104a), servers (such as server 106), may be distributed across one or more user devices and servers, or be implemented in the cloud. Moreover, in some embodiments these components of system 200 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the invention described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

As noted above, it should be understood that the meeting management system 200 shown in FIG. 2 is an example of one system in which embodiments of the present invention may be employed. Each component shown may include one or more computing devices similar to the operating environment 100 described with reference to FIG. 1. The meeting management system 200 should not be interpreted as having any dependency or requirement related to any single module/component or combination of modules/components illustrated therein. Each may comprise a single device or multiple devices cooperating in a distributed environment. For instance, the meeting management system 200 may comprise multiple devices arranged in a distributed environment that collectively provide the functionality described herein. Additionally, other components not shown may also be included within the network environment. It should be understood that the meeting management system 200 and/or its various components may be located anywhere in accordance with various embodiments of the present disclosure.

The meeting management system 200 generally operates to determine meeting event patterns and/or trends for user profiles generate meeting attendance models and provide services for optimizing proposed meetings, which may include automatically determining the features of proposed meetings and/or suggesting features of proposed meetings. As briefly mentioned above, each component of the meeting management system 200, including user-data collection component 210, presentation component 220, meeting event pattern inference engine 230, meeting attendance model generator 240, user profile 250, meeting manager 260, and user activity monitor 280, and their respective subcomponents, may reside on a computing device (or devices). For example, the components of meeting management system 200 may reside on the exemplary computing device 600 described below and shown in FIG. 6, or similar devices. Accordingly, each component of the meeting management system 200 may be implemented using one or more of a memory, a processors or processors, presentation components, input/output (I/O) ports and/or components, radio(s) and a power supply (e.g., as represented by reference numerals 612-624, respectively, in FIG. 6).

User-data collection component 210 is generally responsible for accessing or receiving (and in some cases also identifying) meeting data from one or more data sources, such as data sources 104a and 104b through 104n of FIG. 1. In some embodiments, user-data collection component 210 may be employed to facilitate the accumulation of user data of a particular user (or in some cases, a plurality of users including crowd-sourced data) for user activity monitor 280 and meeting event pattern inference engine 230. The data may be received (or accessed), and optionally accumulated, reformatted and/or combined, by user-data collection component 210 and stored in one or more data stores such as storage 225, where it may be available to other components of system 200, where it may be available to other components of the meeting management system 200. For example, the user data may be stored in or associated with a user profile 250, as described herein. In some embodiments, any personally identifying data (i.e. user data that specifically identifies particular users) is either not uploaded from the one or more data sources with user data, is not permanently stored, and/or is not made available to user activity monitor 280 and meeting event pattern inference engine 230. In one embodiment, the user data includes meeting data elements (or meeting features) of meetings or events associated with users, and the user-data collection component 210 may be configured to associate each of the meeting data elements with one or more user profiles corresponding to the user, and to store the associated meeting data elements in a corresponding user profile.

User data, which may include meeting data, may be received from a variety of sources where the data may be available in a variety of formats. For example, in some embodiments, user data received via user-data collection component 210 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant”) application or service, home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein. In some embodiments, user data may be provided in user-data streams or “user signals,” which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, or as needed.

User data, particularly in the form of event data and/or location data can be received by user-data collection component 210 from one or more sensors and/or computing devices associated with a user. While it is contemplated that the user data is processed, by the sensors or other components not shown, for interpretability by user-data collection component 210, embodiments described herein do not limit the user data to processed data and may include raw data.

User activity monitor 280 is generally responsible for monitoring user data or information that may be used for determining user activity information, which may include identifying and/or tracking features (sometimes referred to herein as “variables,” such as meeting features or variables) or other information relating to meeting events associated with a user. Embodiments of user activity monitor 280 may determine, from the monitored user data, user activity associated with a particular user, which may include when the user participates (or in some instances does not participate) in a meeting or event. As described previously, the user activity information determined by user activity monitor 280 may include user activity information from multiple user devices associated with the user and/or from cloud-based services associated with the user (such as email, calendars, social-media, or similar information sources), and which may include contextual information associated with the identified user activity. User activity monitor 280 may determine current or near-real-time user activity information and may also determine historical user activity information, in some embodiments, which may be determined based on gathering observations of user activity over time, accessing user logs of past activity (such as browsing history, for example), which may be stored in user account(s)/activity data 253 in a user profile 250. Further, in some embodiments, user activity monitor 280 may determine user activity (which may include historical activity) from other similar users (i.e. crowdsourcing), as described previously. For example, user data from other users co-located with the user during a meeting event may be analyzed to determine attendance, attendee participation or involvement, or additional meeting features.

In some embodiments, information determined by user activity monitor 280 may be provided to meeting event pattern inference engine 230 including information regarding the current context and historical features (historical observations, which may be provided from records of meeting history 256, in user profile 250). Some embodiments may also provide user meeting activity information, such as information related to scheduled meeting events, to meeting manager 260. As described previously, the user activity features determined by user activity monitor 280 may include user data, including meeting-related information, from multiple user devices associated with the user (e.g., personal computer and mobile phone) and/or from cloud-based services associated with the user (such as email, calendars, social-media, or similar information sources), and which may include contextual information associated with the identified user meeting information.

In some embodiments, the user data and/or information about user activity determined from user activity monitor 280, including meeting-event related information, is stored in a user profile, such as user profile 250. In an embodiment, user activity monitor 280 comprises one or more applications or services that analyze information detected via one or more user devices used by the user and/or cloud-based services associated with the user, to determine meeting-related activity information and related contextual information. Information about user devices associated with a user may be determined from the user data made available via user-data collection component 210, and maybe provided to user activity monitor 280, meeting event pattern inference engine 230, or other components of system 200. More specifically, in some implementations of user activity monitor 280, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like.

Some embodiments of user activity monitor 280, or its subcomponents, may determine a device name or identification (device ID) for each device associated with a user profile. This information about the identified user devices associated with a user profile may be stored in a user profile associated with the user profile, such as in user devices 251 of user profile 250. In an embodiment, the user devices may be polled, interrogated, or otherwise analyzed to determine information about the devices. This information may be used for determining a label or identification of the device (e.g. a device id) so that the user profile interaction with device may be recognized from user profile data by user activity monitor 280. In some embodiments, user profiles may declare or register a device, such as by logging into an account via the device, installing an application on the device, connecting to an online service that interrogates the device, or otherwise providing information about the device to an application or service. In some embodiments devices that sign into an account associated with the user profile, such as a Microsoft® account or Net Passport, email account, social network, or the like, are identified and determined to be associated with the user profile.

Accordingly, user activity monitor 280 generally operates to detect user profile activity that is related to meeting events associated with one or more users. As shown in system 200, user activity monitor 280 comprises a meeting event detector 282, contextual information extractor 284, and a meeting event features determiner 286. In some embodiments, user activity monitor 280, one or more of its subcomponents, or other components of system 200, such as meeting attendance model generator 240, or meeting event pattern inference engine 230, may determine interpretive data from received user data. Interpretive data corresponds to data utilized by these components of system 200 or subcomponents of user activity monitor 280 to interpret user data. For example, interpretive data can be used to provide other context to raw user data, which can support determinations or inferences made by the components or subcomponents. Moreover, it is contemplated that embodiments of user activity monitor 280, its subcomponents, and other components of system 200 may use user data and/or user data in combination with interpretive data for carrying out the objectives of the subcomponents described herein. Additionally, although several examples of how user activity monitor 280 and its subcomponents may identify user profile activity information are described herein, many variations of user profile activity identification and user profile activity monitoring are possible in various embodiments of the disclosure.

Meeting event detector 282, in general, is responsible for determining (or identifying) a meeting event has occurred. Embodiments of meeting event detector 282 may be used for determining current meeting events, including meeting-related activity, or historical meeting events. Some embodiments of meeting event detector 282 may monitor user data for meeting-related features or variables corresponding to user activity such as communications received (e.g., meeting requests or calendar-related communications), indications of applications launched or accessed, files accessed, modified, copied, etc., websites navigated to, online content downloaded and rendered or played, user location or change of location (e.g. user is located in or has changed locations to a conference room) or similar user activities.

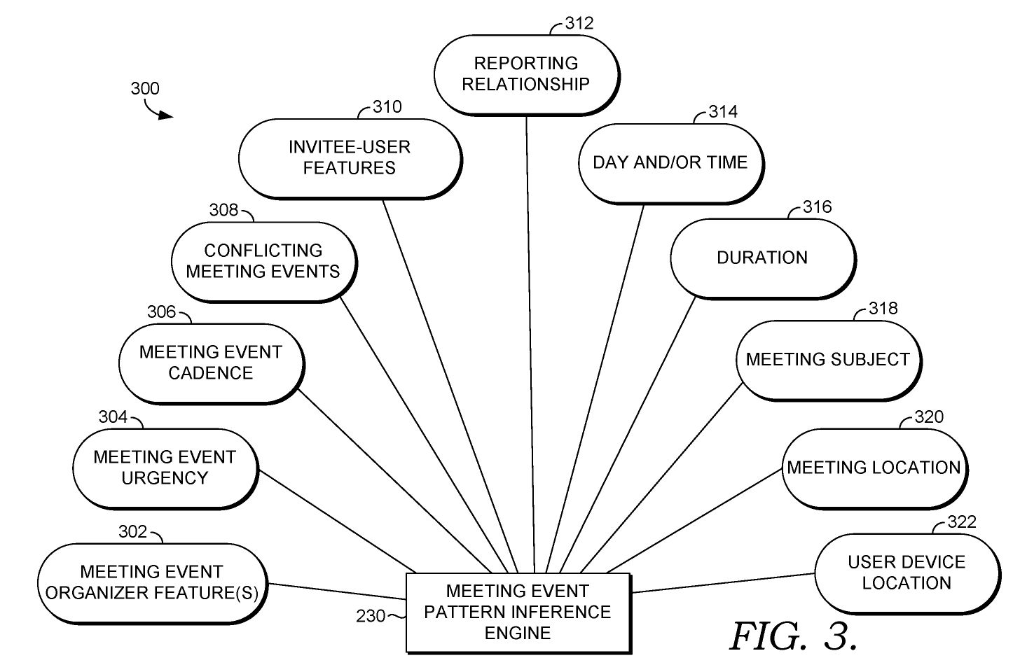

Additionally, some embodiments of meeting event detector 282 extract from the user data information about meeting events, which may include current meeting-related activity, historical meeting-related activity, and/or related information such as contextual information. (Alternatively or in addition, in some embodiments contextual information extractor 284 determines and extracts contextual information that is related to one or more meeting events. Similarly, in some embodiments, meeting event features determiner 286 extracts information about meeting-related activity, such meeting event related features, based on an identification of the meeting event determined by meeting event detector 282.) Examples of extracted meeting-related activity information, referred to herein as meeting features, may include the example meeting features such as the example meeting features described in connection to FIG. 3, app usage, online activity, searches, calls, usage duration, application data (e.g. meeting requests, emails, messages, posts, user profile status, notifications, etc.), or nearly any other data related to a user that is detectable via one or more user devices or computing devices, including user interactions with the user device, activity related to cloud services associated with the user (e.g., calendar or scheduling services), online account activity (e.g. email and social networks), and social network activity. Among other components of system 200, the extracted meeting event information determined by meeting event detector 282 may be provided to other subcomponents of user activity monitor 280, meeting event pattern inference engine 230, meeting manager 260, or other components of system 200. Further, the extracted meeting event information may be stored in a user profile associated with the user, such as in meeting history 256 of user profile 250. In some embodiments, meeting event detector 282 or user activity monitor 280 (or its other sub components) performs conflation on the detected meeting-related information. For example, overlapping information may be merged and duplicated or redundant information eliminated.

In some embodiments, the meeting-related features may be interpreted to determine a meeting event has occurred. For example, in some embodiments, meeting event detector 282 employs meeting event logic 285, which may include rules, conditions, associations, classification models, or other criteria to identify meeting-related activity. For example, in one embodiment, meeting event logic 285 may include comparing meeting event criteria with the user data in order to determine that a meeting event has occurred. In some embodiments, the identification and/or classifying of meeting events can be based on feature-matching or determining similarity in features, which may be carried out using statistical classification processes Thus, meeting event logic 285 may comprise pattern recognition classifier(s), fuzzy logic, neural network, finite state machine, support vector machine, logistic regression, clustering, or machine learning techniques, similar statistical classification processes or, combinations of these to identify meeting events from user data. Accordingly, the meeting event logic 285 can take many different forms depending on the mechanism used to identify a meeting event, and may be stored in storage 225. For example, meeting event logic 285 might include training data used to train a neural network that is used to evaluate user data to determine when a meeting event has occurred. Moreover, meeting event logic 285 may specify types of meeting features or user activity such as specific user device interaction(s), that are associated with a meeting event, accessing a schedule or calendar, accessing materials associated with a meeting (e.g. an agenda or presentation materials), composing or responding to a meeting request communication, acknowledging a notification, navigating to a website, or launching an app. In some embodiments, a series or sequence of user-related activity may be mapped to a meeting event, such that the meeting event may be detected upon determining that the user data indicates the series or sequence of user-related activity has occurred or been carried out by the user.

In some embodiments, meeting event detector 282 runs on or in association with each user device for a user. Meeting event detector 282 may include functionality that polls or analyzes aspects of the user device, which may include online- or cloud-services accessible via the user device, to determine meeting-related features, such as sensor output, applications running (and in some instances the content of the applications), network communications, online/cloud activity related to the user, and/or other user actions detectable via the user device including sequences of actions.

Contextual information extractor 284, in general, is responsible for determining contextual information related to the user profile activity (detected by meeting event detector 282 or user activity monitor 280), such as context, features or variables associated with a meeting event, related information, other user-related activity, and further responsible for associating the determined contextual information with the related meeting event. In some embodiments, contextual information extractor 284 may associate the determined contextual information with the related meeting event and may also log the contextual information with the associated meeting event. Alternatively, the association or logging may be carried out by another service. For example, some embodiments of contextual information extractor 284 provide the determined contextual information to meeting event features determiner 286, which determines meeting event features of the meeting event and/or related contextual information.

Some embodiments of contextual information extractor 284 determine contextual information related to a meeting event such as entities related to the meeting (e.g., other people present during the meeting event or invited to the meeting event, such as recipients of a group email related to the meeting event) or the location or venue wherein the meeting event took place. By way of example and not limitation, this may include context features such as location data; which may be represented as a location stamp associated with the meeting event; contextual information about the location, such as venue information (e.g. this is the user's office location, home location, conference room, library, school, restaurant, move theater, etc.) time, day, and/or date, which may be represented as a timestamp associated with the meeting event and which, in some embodiments, may include yellow pages identifier (YPID) information; duration of the meeting event, which may be different than a scheduled duration (i.e., the meeting was longer or shorter than scheduled); other user meetings or activities preceding and/or following the meeting event, other information about the meeting such as entities associated with the meeting (e.g. venues, people, objects, etc. which may be invited, in attendance, involved in planning, or otherwise involved), information detected by sensor(s) on user devices associated with the user that is concurrent or substantially concurrent to the meeting event (e.g. location, motion information, online activity, user-device interactions, or physiological information detected on a fitness tracking user device), or any other information related to the meeting event that is detectable that may be used for determining patterns user-related activity associated with meetings related to the user.

In embodiments using contextual information related to user devices, a user device may be identified by detecting and analyzing characteristics of the user device, such as device hardware, software such as operating system (OS), network-related characteristics, user accounts accessed via the device (e.g., online calendars), and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user profile. This information about the identified user devices associated with a user profile may be stored in a user profile associated with the user profile, such as in user devices 251 of user profile 250. In an embodiment, the user devices may be polled, interrogated, or otherwise analyzed to determine contextual information about the devices. This information may be used for determining a label or identification of the device (e.g. a Device ID, as described previously,) so that user profile activity on one user device may be recognized and distinguished from user profile activity on another user device. Further, as described previously, in some embodiments, user profiles may declare or register a user device, such as by logging into an account via the device, installing an application on the device, connecting to an online service that interrogates the device or otherwise providing information about the device to an application or service. In some embodiments devices that sign into an account associated with the user, such as a Microsoft® account or Net Passport, email account, social network, or the like, are identified and determined to be associated with the user.

In some implementations, contextual information extractor 284 may receive user data from user-data collection component 210, parse the data, in some instances, and identify and extract context features or variables (which may also be carried out by meeting event features determiner 286). Context variables may be stored as a related set of contextual information associated with the meeting event, and may be stored in a user profile such as in user account(s) and activity data 253. In some cases, contextual information may be used as context-related meeting features by meeting event pattern inference engine 232, such as for determining semantic information or identifying similar meeting features (including context-related features) in meeting events to determine a meeting pattern. Contextual information also may be determined from the user data of one or more users, in some embodiments, which may be provided by user-data collection component 210 in lieu of or in addition to user meeting information for the particular user. In an embodiment, the contextual information is stored with the corresponding meeting event(s) in meeting history 256 in user profile 250.

Meeting event features determiner 286 is generally responsible for determining meeting-related features (or variables) associated with the meeting event that may be used for identifying patterns of user meetings. Meeting features may be determined from information about a meeting event and/or from related contextual information. In some embodiments, meeting event features determiner 286 receives user-meeting or related information from user activity monitor 280 (or its subcomponents), and analyzes the received information to extract or otherwise determine a set of zero or more features associated with the meeting event. The meeting event features may be stored in meeting history 256 and/or made available to meeting event pattern inference engine 230 for determining meeting patterns based on the determined features. For example, common features for different meeting events can be used to help establish a meeting pattern.

Examples of meeting-related features, which are further discussed in FIG. 3, include: information extracted from meeting requests or meeting-related communications, such as time/date, scheduled duration, invitees, importance, responses (e.g. acceptance, tentative-acceptance, declines) proposals or suggestions of alternative times/dates/locations/attendees/other meeting features, meeting subject(s), file attachments or links in meeting-related communications, which may include content of the attachments or links, metadata associated with file attachments or links (e.g., author, version number, date, URL or website-related information, etc.); whether the meeting is recurring; meeting features from previous meetings or future meetings (where the meeting is part of a series, such as recurring meetings); location-related features, such as location of a meeting event, location of user device(s) during the meeting event (which may indicate whether a user is present, not present, or attending remotely), venue-related information associated with the location, or other location-related information; time related features, such as time(s) of day(s), day of week or month the meeting event, or the duration of the meeting event, or related duration information such as how long the user used an application associated with the meeting event or how long a user traveled to attend the meeting event; user device-related features (which in some embodiments may be used for identifying user attendance (physical or remote), participation, and/or involvement at meeting events), such as device type (e.g. desktop, tablet, mobile phone, fitness tracker, heart rate monitor, etc.) hardware properties or profiles, OS or firmware properties, device IDs or model numbers, network-related information (e.g. mac address, network name, IP address, domain, work group, information about other devices detected on the local network, router information, proxy or VPN information, other network connection information, etc.), position/motion/orientation related information about the user device, power information such as battery level, user-access/touch information; usage related features, such as file(s) accessed, app usage (which may also include application data, in-app usage, concurrently running applications), network usage information, online activity (e.g. meeting subject related searches, browsed websites, social networking activity related to the meeting, communications sent or received including social media posts, user account(s) accessed or otherwise used, (such as device account(s), OS level account(s), or online/cloud-services related account(s) activity, such as Microsoft® account or Net Passport, online storage account(s), email, calendar, or social networking accounts, etc.), features that may be detected concurrent with the meeting event or near the time or the meeting event, or any other features that may be detected or sensed and used for determining a pattern of meeting-related activity for the user.

In one example, meeting-related features include a meeting attractiveness, which may be determined based on speakers, presentations, or topics scheduled for the meeting; for example a meeting with a high-level speaker or famous celebrity may be determined to be more attractive. In an embodiment, the meeting attractiveness may be determined based on attractiveness to a particular user or group of similar users. For example, a level or measure of attractiveness may be determined for a user (or group) based on an analysis of information about the user, such as social media activity (e.g a social network profile), browsing history, interests, or other information about the user, which may accessible via user accounts/activity data 253.

In some embodiments, meeting-related features may be determined based on an analysis of other meeting-related features or meeting-related information. For example, another example meeting-related feature that may be determined in some embodiments includes meeting sensitivity, which may be determined as a level or measure of the sensitive nature of a meeting based on its attendees/invitees, topics, location, or other features related to the meeting. In one instance, a meeting having only top-level invitees, such as an executive committee or board of directors, may be determined to be sensitive. In another instance, a meeting request marked “confidential” may be determined to be sensitive.

Meeting features may also include information about user(s) using the device; other information identifying a user, such as a login password, biometric data, which may be provided by a fitness tracker or biometric scanner; and/or characteristics of the user(s) who use the device, which may be useful for distinguishing users on devices that are shared by more than one user. In some embodiments, meeting event logic 285 (described in connection to meeting event detector 282) may be utilized to identify specific features from meeting-related information.

Continuing with system 200 of FIG. 2, meeting event pattern inference engine 230 is generally responsible for determining meeting patterns based on the meeting event information determined from user activity monitor 280, meeting-related information stored in storage 225, which may include historical meeting-related information, which may be determined from user activity monitor 280, and/or user data received from user-data collection component 210. In some embodiments, meeting event pattern inference engine 230 may run on a server, as a distributed application across multiple devices, or in the cloud. At a high level, meeting event pattern inference engine 230 may receive meeting event data, which may be provided from user activity monitor 280, or its subcomponents, user-data collection component 210, and/or user meeting event history from client-side applications or services associated with user activity monitor 280, or which may be stored in a user profile 250. One or more inference algorithms may be applied to the meeting event-related information to determine a set of likely meeting event patterns. For example, patterns may be determined based on similar instances of observation of meeting events or associated contextual information, which may be referred to as “in-common features” of meeting event-related information. The inferred meeting event pattern information may be provided to a meeting attendance model generator 240 and/or used to generate a pattern based prediction regarding the likely future user activity associated with future meetings, such a likelihood of attendance by the user, relevance of a meeting to the user, importance of attendance by the user, etc., given various meeting features (e.g. meeting times, duration, location, other invitees, or other features.) In some embodiments, a corresponding confidence is also determined for the patterns (or predictions based on the patterns), as described herein.

Meeting event pattern inference engine 230, or its subcomponents, may operate to analyze meeting data elements, such as meeting-event features, collected by the user-data collection component 210. The meeting data elements may be, for example, meeting data elements associated with a plurality of prior or current meeting events. The meeting data elements may be meeting data elements from one or more calendaring/scheduling applications, email, direct messaging, and/or electronic personal assistant (e.g., Cortana) associated with the user, or other meeting features described in connection with meeting event features determiner 286 and/or FIG. 3. The meeting data elements may also include data elements produced by user devices 102a-102b including, but not limited to, real-time user device location data and past user device location data related to prior meeting events. Meeting event pattern inference engine 230 may employ a variety of subcomponents to analyze the meeting event features or other meeting data elements.

As shown in example system 200, meeting event pattern inference engine 230 comprises historical meeting events identifier 231, semantic information analyzer 233, features similarity identifier 234, and meeting pattern determiner 236. Historical meeting events identifier 231 may be configured to identify a plurality of prior or current meeting events for a user, which may be considered for determining a meeting pattern. The prior or current meeting events may be identified, for example, from meeting event information provided by user activity monitor 280 (or its subcomponents, such as meeting event detector 282), from meeting history 256, or in some embodiments, may be determined from parsing meeting data elements and related user data received from user-data collection component 210. Historical meeting events identifier 231 may operate continually such as when new meeting-event related information becomes available, at fixed intervals, or as needed, to detect prior meeting events.

Semantic information analyzer 233 is generally responsible for determining semantic information from meeting event-related information associated with the meeting events identified by historical meeting events identifier 231 and/or user activity monitor 280. The meeting event information may include meeting event features, such as the features determined by meeting event features determiner 286, and may also include contextual features or other contextual information. For example, while a meeting event feature may indicate a location feature associated with a meeting event, semantic analysis may determine related information to this feature such as (a) whether a user traveled to attend the meeting (including traveling to another building or floor) and in some instances, how long it took the user to travel to the meeting, or if the user had to travel outside and what the weather was like, (b) other attendees at the location; (c) the venue of the location; (d) whether food or coffee is available at the location, or other information related to the meeting event features.

Accordingly, semantic information analyzer 233 may determine additional meeting event-related features semantically related to the features of meeting events identified by historical meeting events identifier 231 and/or user activity monitor 280, and that may be used for identifying meeting patterns of the user. For example, the user always attended meetings within 2 weeks of a major project deadline. Or, the user attended meetings that required travel to another building, if the weather was nice or fair, but did not attend when the weather was cold or rainy. (Here, meeting features for meeting location, date/time, and the user's location may be used to determine semantic information, such as the outside weather conditions at that location and time.) In some embodiments, the semantic information is stored as a related set of semantic features associated with a prior or current meeting event and/or a particular user or user device activity within a time interval before and after the meeting event.

Semantic information analyzer 233 may also be used to characterize contextual information associated with the meeting event, such as determining that a location associated with the meeting event corresponds to a hub or venue of interest to the user (such as the user profile's work, home, or the like) based on frequency of user visits. For example, the user's home hub may be determined (using semantic analysis logic) to be the location where the user profile spends most of her time between 8 PM and 6 AM. Similarly, the semantic analysis may determine time of day that correspond to working hours, lunchtime, commute time, etc. Semantic information analyzer 233 may also operate to detect meeting event responses for each historic or current meeting event. The meeting event responses may be associated with a meeting event response type, such as: accepted, rejected, proposed a new time, responded as tentative, and/or did not respond. In some embodiments, each meeting event for a user identified by historical meeting events identifier 231 may be stored (for example in meeting history 256 of user profile 250) with an indication of the meeting response type. In this way, the semantic analysis provided by semantic information analyzer 233 may provide other relevant features of meeting event events that may be used for determining meeting event patterns for a user.

In particular, as described previously, a semantic analysis may be performed on the meeting event-related information, which may include the contextual information (which may be determined by contextual information extractor 284), to characterize aspects of the meeting event. For example, in some embodiments, meeting event features associated with a meeting event may be classified or categorized (such as by type, timeframe or location, subject-related, themes, related entities, other user(s) (such as communication to or from another user) and/or relation of the other user to the particular user (e.g. Supervisor, colleague, client), or other categories), or related features may be identified for use in determining a similarity or relational proximity to other meeting events, which may indicate a pattern. Further, in some embodiments, semantic information analyzer 233 may utilize a semantic knowledge representation, such as a relational knowledge graph. Semantic information analyzer 233 may also utilize semantic analysis logic, including rules, conditions, or associations to determine semantic information related to the meeting event. The semantic information determined by semantic information analyzer 233, which may include semantic features, may be stored along with meeting event features (which may include contextual features) already determined for the meeting event, and stored in a user profile for the user, such as in meeting history 256 of user profile 250.

Features similarity identifier 234 is generally responsible for determining similarity of meeting event features of two or more meeting events (put another way, meeting event features characterizing a first meeting event that are similar to meeting event features characterizing a second meeting event). The meeting event features may include features relating to contextual information and features determined by semantic information analyzer 233. Meeting events having in-common meeting event features may be used to identify a meeting pattern or sub pattern for a user, which may be determined using meeting pattern determiner 236. For example, in some embodiments, features similarity identifier 234 may be used in conjunction with meeting pattern determiner 236 to determine a set of meeting events that have in-common features. In some embodiments, this set of meeting event data may be used as inputs to a pattern based predictor, such as a meeting attendance model generator 240, as described below.

Meeting pattern determiner 236 is generally responsible for determining a meeting event based on similarities identified in meeting event information. In particular, meeting pattern determiner 236 (or meeting event pattern inference engine 230) may determine a meeting pattern for a user based on repetitions of similar meeting event features associated with a plurality of observed meeting events. Thus, for example, a meeting event pattern may be determined where meeting event features corresponding to two or more meeting events are similar. In some instances, a meeting event may have many corresponding meeting event features, which may be represented as a feature vector associated with a particular meeting event. Accordingly, the analysis carried out by meeting pattern determiner 236 may involve comparing the meeting event features from features vectors of plurality of meeting events.

In some embodiments, meeting event patterns may be determined using pattern inferences logic 235. Pattern inferences logic 235 may include rules, associations, conditions, prediction and/or classification models, or pattern inference algorithms. The pattern inferences logic 235 can take many different forms depending on the particular meeting pattern or the mechanism used to identify a meeting pattern, or identify feature similarity among observed meeting event data to determine the pattern. For example, some embodiments of pattern inferences logic 235 may employ machine learning mechanisms to determine feature similarity, or other statistical measures to determine the meeting event data belonging to a set of “example user activity” that support the determined meeting pattern, as further described below. In some embodiments, the meeting pattern(s) determined by meeting pattern determiner 236 may be stored as meeting patterns 237 and/or provided to meeting attendance model generator 240, which may determine one or more inferred meeting attendance model(s) 252 from the pattern(s).

In some embodiments, meeting pattern determiner 236 provides a meeting pattern and an associated confidence score regarding the strength of the meeting pattern, which may reflect the likelihood that a user will follow the pattern for future meeting events. More specifically, in some embodiments, a corresponding confidence weight or confidence score may be determined regarding a determined meeting pattern for a user. The confidence score may be based on the strength of the pattern, which may be determined based on the number of observations (i.e. the number of meeting events) used to determine a meeting pattern, how frequently the user activity is consistent with the meeting pattern, the age or freshness of the activity observations, the number of similar features, types of features, and/or degree of similarity of the features in common with the activity observations that make up the pattern, or similar measurements.

In some instances, the confidence score may be considered when providing a determined meeting pattern to meeting attendance model generator 240. For example, in some embodiments, a minimum confidence score may be needed before using the meeting pattern to infer meeting attendance based on the pattern. In one embodiment, a threshold of 0.6 (or just over fifty percent) is utilized such that only meeting patterns having a 0.6 (or greater) likelihood of predicting user actions with regards to a meeting may be may be provided. Nevertheless, where confidence scores and thresholds are used, determined patterns of meeting events with confidence scores less than the threshold may still be monitored and updated based on additional meeting event observations, since the additional observations of may increase the confidence for a particular pattern.

Some embodiments of meeting pattern determiner 236 determine a pattern where each instance of a meeting event data has corresponding historical values of tracked meeting event features (variables) that form patterns, and where meeting pattern determiner 236 may evaluate the distribution of the tracked variables for patterns. In one instance, a tracked variable for a meeting event data is a timestamp corresponding to an observed instance of the meeting event data. However, it will be appreciated that, conceptually, many different types of historical values for tracked meeting event features (variables) may be used. Further, it should be appreciated that the meeting pattern determine or 236 may determine patterns for prior meeting events based on any number of features.

By way of example and not limitation, meeting patterns may include patterns of responses to prior meeting events from each user stored within a meeting management system; responses to prior meeting events when the user had two or more conflicting prior meeting events; responses to prior meeting events based on a number of invitees or specific individuals invited; responses to similar prior meeting events by other similar users (crowdsourcing); responses to prior meeting events with a common day/time features; responses to prior meeting events based on a scheduled duration of the prior meeting events; responses to prior meeting events based on a subject of the prior meeting events; responses to prior meeting events based on a common location; responses to prior meeting event with a common urgency; responses based on other similar contextual or semantic features (such as the occurrence of an upcoming project deadline, proximity of the meeting time to a holiday or weekend (e.g. a meeting scheduled for Friday afternoon or the day before a major holiday) and/or responses to prior meeting events based on a location of one or more user devices associated with the user.

In another aspect, each meeting event with a common response may be determined. For instance, for each meeting event having a meeting a common response type, the meeting pattern determiner 236 may determine one or more patterns corresponding to one or more of: a common time; a common day; a common date; a common location; a common duration; a common urgency; a common cadence; and/or a common subject of each prior meeting event, for example. The meeting pattern determiner 236 also may determine, for example, one or more patterns in the response types corresponding to: a common meeting organizer user profile; a common user profile reporting relationship to the user profile of the meeting organizer user profile; conflicting meetings; and/or a common number of invitee user profiles associated with the prior meeting events. For example, each prior meeting event having a common response type of accepted may be analyzed to determine one or more common features. Thus in one instance, if each accepted meeting has a meeting data elements corresponding to a day of Monday through Thursday, it may be inferred that a proposed meeting for the user on a Tuesday is more likely to be accepted. (Such an inference may be determined by a likelihood of attendance determiner 266, described below.) Negative instances may also be inferred based on the same information/meeting data elements, for instance that a proposed meeting for the user on a Friday or Saturday is unlikely to be accepted. Patterns also may be detected based on a deviation from a determined trend and/or pattern. For example, a user that has demonstrated a pattern of rejecting prior meeting events on Friday afternoon may display a deviation when the meeting invitation is associated with a specific individual, for example a vice president within the organizational hierarchy. It should be appreciated that the above examples are highly simplified examples used to demonstrate various aspects disclosed herein. Any number of other patterns and inferences may be determined based on a much more nuanced analysis of the meeting events and in common features.

Meeting attendance model generator 240 is generally responsible for determining one or more meeting attendance models for a user, which may be used to predict user attendance and/or related inferences (e.g. whether a user will attend in person or call in, how much they will participate, whether they will leave early/arrive late, etc.). In some ways, meeting attendance models generated by meeting attendance model generator 240 may reflect predicted user responses for any number of meeting event scenarios having any number of features. Meeting attendance model generator 240 may be configured to generate a meeting attendance model for each user within the meeting management system 200, based on one or more meeting patterns determined for the user. Additionally, to construct meeting attendance model(s), meeting attendance model generator 240 may incorporate information provided from meeting event pattern inference engine 230, user -user-data collection component 210, user activity monitor 280, and/or information provided from other components or subcomponents of system 200.

As shown in system 200, the example meeting attendance model generator 240 includes a meeting event pattern (MEP) compiling component 242, existing meeting detection component 244, and availability determiner 246. MEP compiling component 242 may operate to compile one or more meeting event patterns for a user determined by the meeting pattern determiner 236 or meeting event pattern inference engine 230. In particular, according to a compilation of one or more meeting patterns, an attendance model may be determined and used to infer user attendance or related aspects for future meetings. In some embodiments, MEP compiling component provides a meeting attendance model that may be further tailored based on existing scheduled meetings for a user and the user's expected availability, which may be determined by components 244 and 246, respectively. In some embodiments, MEP compiling component 242 also may gather semantic information, features, categories, and any other meeting event related data/information available via meeting management system 200 for use in the determined meeting attendance model.

Existing meeting detection component 244 generally operates to provide the meeting attendance model generator 240 with meeting event data for scheduled meeting events associated with the user. The existing meeting event data may be accessed or migrated from one or more user devices associated with the user, online or cloud services associated with the user, calendaring/scheduling applications, email, direct messaging, social network activity, and/or electronic personal assistant (e.g., Cortana) associated with the user. This information may be used for determining availability of the user using availability determiner 246.

Availability determiner 246 is generally responsible for determining user availability for participating in meeting events, including, in some embodiments, current availability and/or future availability (or forecasted availability). The determined availability may be incorporated into an attendance model produced by meeting attendance model generator 240, and may reflect a degree of availability or how the user is available, which may be used to determine likelihood of user attendance or related aspects, such as whether the user is likely to attend in person, call in, leave early/arrive late, etc. Some embodiments of availability determiner 246 infer or predict a user's availability for participating in meeting events at future time intervals, based on user data and information provided by user activity monitor 280 or other components (or subcomponents) of system 200, as further described below.

The determined user availability information, which may be represented as a set of availability score(s), may be based in part on a user's capacity or capability for participating in a meeting event. In some instances or for some users, user availability for attending a meeting does not equate to user attendance. Rather, even where a user is determined to be available, the user may not attend because he or she feels it is not important, has other things to do, or for other reasons, such as described in the examples herein. Thus, in some embodiments, the user's availability determined by component 246 represents an aspect of an attendance model for the user; the meeting patterns, determined by meeting pattern determiner 236 or meeting event pattern inference engine 230, reflect the user's past behavior and thus may provide details used to determine whether a user is likely to attend a meeting when the user is available.

In some embodiments, the availability information may be represented as an aspect or sub-model of the meeting attendance model, and may be stored in a user profile 250 associated with the user, such as in meeting attendance model 252. For example, it may be determined that a user commutes every weekday from 8:00 to 8:30 AM and thus may not have the capability for attending a meeting in person during this time, but may be available for calling into the meeting. After 8:30 AM, however, the user is likely to be in her office and thus has availability for attending in person or over her computer. But where the calendar indicates a holiday or that the user will be out of the office traveling, then the forecasted availability information of the user (such as an availability sub-model, in some embodiments) may be adjusted to indicate the user is not available to attend in person or possibly not available at all, which may be reflected in an availability score. In particular, in an embodiment a set of scores may indicate the user's availability for attending in person, over the phone, over the computer, such as via a meeting web portal or other means. Further, in some such embodiments, the availability information may be represented as a matrix indicating a set of availably scores corresponding to different aspects of availability, such as calling in, attending in person, over the internet, arriving late, leaving early, whether the user has meetings scheduled before or after a particular meeting, the user's likelihood of attending other meetings adjacent to a particular meeting, etc.

The determined user availability information, which may be referred to as an availability schedule, may be used for determining likelihood of attendance for the user by meeting manager 260. For example, as further described below, in one embodiment the determined availability along with an importance level or score reflecting a level of importance that the particular user attends a particular meeting, may be used for determining optimal meeting parameters (such as meeting features) for scheduling a proposed future meeting. In particular, the meeting attendance model, including the determined availability, may be used to determine optimal time(s) when a particular user is most likely to attend a proposed future meeting. For example, it may be determined that a user is more likely to attend a certain category of meeting on workday mornings, but not workday afternoons, or that a particular user usually does not attend meetings scheduled between 12:00 and 1:00 PM (which may correspond to when the user is eating lunch), unless a project deadline is within two weeks.

In some embodiments, user availability information may be determined from user patterns (including patterns from other users) based on previous responses or activity related to meeting events, contextual information, and other user data including current user data. For example, a calendar or social network profile associated with the user may be evaluated to identify activity related to the user, such as a baseball game activity identified from a social network post and message between the user and another user. In another example, availability information may be determined in part from contextual features associated with a user device (e.g., a device location, a device time, a mode of transportation, a device location check-in, an alarm, a charging state, a connectivity state, or user data stored on the device), such as a video game console pre-order receipt stored on the device may be evaluated to identify a video game console release pick-up activity. In a further example, the user signal may comprise temporal information, locational information, and/or a wide variety of information that may be used to identify an activity (e.g., recurring) based upon the user signal (e.g., the device may have a location corresponding to a breakfast restaurant on Saturdays, which may indicate the user has a routine of eating breakfast at the breakfast restaurant on Saturdays).

In still another example, user availability may be determined using calendar information from one or more user calendars, such as office calendars, personal calendars, social media calendars, or even calendars from family members or friends of the user, in some instances. Some embodiments of the invention may construct a complementary or shadow calendar for a user, for use in determining availability. In particular, in such embodiments, the complementary or shadow calendar maybe used for creating an availability schedule or sub-model of the user.

In an embodiment, the complementary calendar may be constructed based upon sensor data associated with a user of a device. For example, a social network profile (e.g., social network posts, social network messages, a user profile indicating hobbies or interest of the users, etc.) may be evaluated to identify an activity of the user as a particular sensor data. In another example, a context of the user's device may be evaluated to identify an activity of the user as the sensor data (e.g., a device location may be indicative of the user going to soccer practice at a soccer field on Tuesdays; a device location check-in may be indicative of the user going out on a movie date on Sundays (e.g., the user may check-in through a social network); a connectivity state, such as Wi-Fi connectivity, may indicate that the user is at home, in the office, or at a coffee shop; a charging state, such as a car charging state, may indicate that the user is currently driving; a vacation itinerary file on the device may indicate that the user will be going on a vacation in a week; etc.).

It may be appreciated that, in some embodiments, a wide variety of information, such as temporal information and/or locational information, may be evaluated to identify sensor data and/or supplement sensor data (e.g., a user's primary calendar may be used to identify conflicts and/or verify activities derived from sensor data; sensor data may be evaluated against real-time data. such as traffic information, weather, or supplemental information, which may include information from the user's social media accounts, family or friends social media accounts, email, news, and other user data (e.g. crowd-sourced data). In this way, the complementary calendar may be constructed with one or more entries derived from sensor data (e.g., automatically generated entries based upon inferred activities). In an embodiment, a complementary calendar may be merged with one or more calendars (e.g., the user's primary calendar, a family calendar, a social network calendar, etc.) to create a shadow calendar comprising at least some of the complementary calendar (e.g., automatically generated entries derived/inferred from sensor data) and at least some of the one or more calendars (e.g., user entries populated within the primary calendar by the user). Scheduling conflicts may be identified based upon the complementary calendar and/or the shadow calendar (e.g., a user entry may indicate that the user has a 9:00-9:30 Monday work meeting and an entry within the complementary calendar may indicate that the user is to meet his a friend for coffee at 9:15 on Monday based upon a social network post).

The determined availability information or attendance model(s) may be updated as the user data or contextual information changes, as described in the previous example. In one embodiment, a likelihood is determined that a user will follow one or more meeting patterns reflected in the attendance model, based on user data (e.g., calendar information, meeting requests, social network feeds, location data, etc.), information from user activity monitor 280, and/or previously determined meeting event pattern(s),

Some embodiments of the present disclosure further include using meeting data elements from other users (i.e., crowdsourcing data) for determining meeting patterns, meeting attendance models, typical user response patterns to meeting events of similar types, and/or relevant supplemental content to build meeting attendance models. Meeting attendance model generator 240 may generate one or more response sub-models for a particular meeting attendance model. Response sub-models may include projected responses to future meetings based on rules or settings, types or categories of events, context features or other meeting features or variables, such as relation between a meeting organizer and the user, and may be learned or inferred as described hereinabove. Accordingly, in an embodiment, meeting attendance models may incorporate compiled prior meeting event patterns, crowdsourcing meeting event data, detected existing meeting events, and current user profile activity, among other inferred or gathered data, to construct meeting attendance models. The generated (or updated) meeting attendance models may be stored in a user profile 250 associated with the user, such as in meeting attendance model 252, as described previously.

Turning briefly to FIG. 3, a diagram is provided illustrating exemplary meeting event features that may be used for determining the meeting patterns used to generate meeting attendance models. In particular, a number of example features 302-322 are described, which may be provided as inputs to meeting event pattern inference engine 230, described in connection to FIG. 2. This illustration is not a limitation of the type or scope of features that may be used. Meeting event organizer feature(s) 302 represents features associated with meeting events based on the meeting organizer or person/user that generated or initiated the meeting event. In an embodiment, user responses to meeting events (including responding to meeting requests and/or attendance in some form) from users in the meeting management system may be used to detect patterns associated with each user. By way of example, if the user has accepted and attended in person every previous meeting event invitation associated with a given organizer, a particular meeting pattern with a high confidence value will likely be identified by meeting pattern determiner 236.

Meeting event urgency feature 304 may be used to identify patterns corresponding to meeting events based on how far in advance each meeting event was proposed. For example, meeting event urgency feature 304 may be used to detect trends corresponding to meeting events proposed on the same day of the meeting event, a week in advance of the meeting event, or a month in advance of the meeting event.

Meeting event cadence feature 306 may be used to identify a pattern corresponding to meeting events based on a recurrence, or lack thereof, associated with the prior meeting events. For example, the meeting event cadence feature 306 may be used to detect patterns among one-time meeting events, recurring monthly meetings, or recurring annual meetings.

Conflicting meeting events feature 308 may be used to detect a pattern among meeting events when the user had two or more conflicting meeting events. For example, if the user profile has displayed a pattern of accepting a first prior meeting event invitation received and declining a second prior meeting event invitation received, this pattern may be detected by meeting pattern determiner 236. In this scenario, the pattern may indicate that a first proposed meeting is more likely to be accepted then a second proposed meeting.

Invitee-user features 310 may be used to detect patterns based on the specific meeting invitees associated with the meeting events, which may include the number of invitees, which specific invitee-users were invited, or other features related to the meeting invitees. For example, if a particular user X's past responses indicate a pattern of rejecting prior meeting events associated with over 10 invitees; a pattern (which may be reflected in a meeting attendance model) for user X may indicate that a proposed meeting associated with 11 or more meeting invitees is unlikely to be accepted.

Reporting relationship feature 312 may be employed to detect patterns based on reporting relationships among meeting organizers, meeting invitees and a given user. For example, if the user displays a pattern of regularly accepting meetings from persons at vice president level or above, this pattern may be identified with a relatively high confidence score. In some embodiments, reporting relationship feature 312 may be used to detect patterns for all users within the meeting management system 200 (i.e., crowdsourcing). These detected patterns may then be incorporated into each user meeting attendance model, such as based on the user's position within an organizational hierarchy.

Day and/or time feature 314 may be used to detect patterns based on the day and/or time of the prior meeting events. For example, this feature may be used to determine if there are any days and/or times that correspond to a pattern of accepting or declining invitations. For example, if a user regularly declined previous meeting events scheduled for after 3:00 PM on Fridays, the meeting pattern determiner 236 (and/or a meeting attendance model) may be used to infer that a proposed meeting at 4:00 PM on Friday is likely to be declined. In some embodiments, meeting pattern determiner 236 is also capable of identifying less apparent trends in day and/or time patterns. For instance, if the user profile displays a pattern of rejecting meetings on the first Monday of the month, a meeting pattern relating only to the first Monday of the month may be identified. Further, meeting pattern determiner 236 may determine that a user displays a pattern of rejecting meetings before LOAM. The meeting pattern determiner 236 (and meeting attendance model) may use this pattern to determine that a proposed meeting with a meeting time of 9 AM is likely to be declined, even though the user calendar does not include an existing meeting event for 9 AM or the user's availability is otherwise determined to indicate that the user is available.

Duration feature 316 may be used to detect a pattern for prior meeting events based on a duration of the prior meeting events. For example, if the user profile has displayed a pattern of accepting invitations for prior meeting events under two hours and declining prior meeting events for meetings scheduled for over two hours, this pattern may be detected. Further, information provided by user activity monitor 280 (or identified by semantic information analyzer 233) may indicate that prior meeting events associated with a one-hour duration typically only last 45 minutes. For example, if a user device indicates a location different from a location of the prior meeting event 45 minutes after the start of the prior meeting event, it may be inferred that the meeting event only lasted 45 minutes.

Meeting subject feature 318 may be used to determine patterns based on a subject of the previous meeting events. The subject of the meeting events may be determined, for example, by contextual information extractor 284, meeting event features determiner 286, or semantic information analyzer 233, for example. For instance, if a user has rarely accepted meeting events with a subject line of “benefits,” the meeting pattern determiner 236 may detect a pattern based on this meeting subject or related subjects. Similarly, the user may display a pattern of nearly always accepting and/or attending meeting events with “compensation” in the subject line.

Meeting location feature 320 may be used to determine a pattern of responses or attendance to meeting events based on a location of the meeting events. For instance, if the user has a history of low acceptance to or attendance of meeting events in building A, a proposed meeting with building A as the location may have a projected meeting response of declined or result in no attendance by this particular user.

User device location feature 322 may be used to detect patterns in meeting responses and/or attendance based on a user device location and the time of the meeting responses. For example, the meeting pattern determiner 236 may identify a pattern of declining meeting events proposed for a Tuesday when the mobile device is located in Seattle, Washington on the prior Monday.

In further embodiments, any number of features and variables may be used to generate meeting event patterns and attendance models. Moreover, additional features may also be added to the meeting management system 200 over time as they are determined to contain relevant patterns and trends based an analysis of prior and current meeting events to increase the accuracy of the meeting attendance models.

Returning to FIG. 2, meeting manager 260 is generally responsible for determining optimal meeting features, which may include recommended invitees, locations, date and/time (which may be provided as a specific date/time or one or more spans of time/dates), subject, duration, or other meeting features. In some embodiments, meeting manager 260 operates in conjunction with a presentation component 220 to provide a user interface for organizing and/or interacting with a proposed meeting. For example, in one embodiment and at a high level, a meeting organizer-user initiates composition of a meeting request or otherwise initiates scheduling a meeting, which invokes meeting manager 260. In an embodiment, meeting manager 260 operates in conjunction with, or is embodied as a component of a meeting scheduling service, which may be cloud-based, such as Microsoft® Exchange. In one embodiment, meeting manager 260 accesses the meeting planning, scheduling, and/or communications resources of Microsoft® Exchange or other mail, calendar, or scheduling services. Meeting manager 260 receives information about the proposed meeting from the meeting organizer, determines optimal meeting features for the proposed meeting, and provides the optimal features as a recommendation, such as a draft meeting invite communication. In one embodiment, meeting manager 260 automatically schedules the meeting or automatically generates and sends a meeting request communication according to the optimal meeting features. Alternatively, in one embodiment, the meeting organizer is provided feedback (which may include visual feedback via presentation component 220) regarding suggestions or recommendations for one or more features. For example, after specifying meeting invitees into a meeting planner user interface, meeting manager 260 may determine an optimal time and location, such as a particular available conference room, that maximizes the likelihood of attendance by those invitees for which attendance has been determined to be important. (For instance, those invitees who are required to be at the meeting.) The user may be shown a notification in or near the meeting planner user interface that reflects the recommended (optimal) features. For example, a suggestion that the meeting organizer change a specific feature such as the time, date, location, or other feature, an indication as to who is likely to attend/not attend given the current proposed meeting features, or a confirmation that certain invitees identified by the meeting organizer are likely to attend given the meeting features for the proposed meeting.

Accordingly, as shown in system 200, example meeting manager 260 comprises a proposed meeting event receiving component 262, meeting attendee importance determiner 264, likelihood of attendance determiner 266, meeting features optimizer 268, and meeting features recommender 270. Embodiments of meeting manager 260, and/or its subcomponents may run on a single computing device, across multiple devices, or in the cloud. For example, in one embodiment where meeting manager 260 operates in conjunction with features provided by Microsoft® Exchange, meeting manager 260 may reside, at least in part on an Exchange server, which may be embodied as server 106, in FIG. 1. Proposed meeting event receiving component is generally responsible for receiving meeting event information for a proposed, future meeting event. The meeting information may be received from a meeting organizer or scheduling service, and may be provided using user-data collection component 210 and/or presentation component 220. In some embodiments, proposed meeting event receiving component 262 extracts meeting features for a proposed meeting from the meeting information. Examples of extracted meeting features may include meeting features similar to those described in connection with meeting event features determiner 286 or in FIG. 3, such as, location information, day/time, attendees (or proposed attendees/invitees), recurrence, subject, urgency, or nearly any other data related to meeting events. In some aspects, proposed meeting event receiving component 262 is configured to receive inputs of meeting features. For example, in an embodiment, proposed meeting event receiving component 262 may be configured to receive an indication of one or more meeting invitees for a proposed meeting. Among other components of system 200, the meeting features for a proposed meeting determined by proposed meeting event receiving component 262 may be provided to other subcomponents of meeting manager 260. Further, these meeting features may be stored in a user profile associated with the particular meeting organizer, such as in a user profile 250.

Meeting attendee importance determiner 264 is generally responsible for determining an importance level for attendance by meeting invitees of the proposed meeting event. In some embodiments, meeting attendee importance determiner 264 may receive meeting features for the proposed meeting from component 262, including features related to invitees. The meeting attendee importance determiner 264 may access user profile(s) 250 and meeting attendance models 252 for each of the meeting invitee to determine an importance score for each invitee. In one aspect, the meeting attendee importance score generally reflects how important it is that a meeting invitee attend the particular proposed meeting based on the features of the proposed meeting and patterns or inferences determined by meeting event pattern inference engine 230. In these embodiments, the importance score may be a numeric value or a rating that reflects a degree of importance of the given attendee in relation to the proposed meeting. For example, an importance score may be reflected by a scale from 1-10, with 10 being the highest, or most important score. Additionally, the meeting attendance models and associated information may be accessed in real-time, or as the proposed meeting invitation is being generated.

The proposed meeting details may be analyzed in relation to the meeting patterns, response models, existing meetings, user profile activity, user accounts activity data 253, and any other information associated with the meeting attendance models 252 and/or user profile(s) 250. Further, any number of features may be used in determining an importance score. For example, if one of the features identified is a subject line having the term “optional,” then none of the meeting invitees may have a significant importance score

Likelihood of attendance determiner 266 generally is responsible for determining a likelihood that invitees to a proposed meeting will attend given the meeting features of the proposed meeting, which may be provided by a meeting organizer. In some embodiments, the likelihood of attendance may be determined based on current features associated with the proposed meeting and meeting attendance models (such as those determined by meeting attendance model generator 240) for each invitee. In an embodiment, a likelihood of attendance is determined for each invitee, and may be represented by a value that reflects the forecasted likely response to a proposed meeting or attendance at the meeting. In some embodiments, likelihood of attendance may also forecast how a particular invitee is likely to attend (e.g. in person, calling-in, online, etc.) and/or a degree of participation by the invitee.

In some embodiments where a value is determined indicating likelihood of attendance or response to a proposed meeting, the value may be reflected as a percentage chance that the meeting invitee will accept the proposed meeting, which may be displayed to the meeting organizer, via presentation component 220, such as via an indication on a meeting planner user interface.

As described above, the likelihood of attendance may be inferred based on the proposed meeting features and meeting attendance models for the invitees, which may be stored in a user profile corresponding to each invitee. Thus, in one aspect, likelihood of attendance determiner 266 may access user profile(s) 250 for each of the meeting invitees or for invitees with importance scores above a certain threshold (such as above eight on a ten-point scale).

In some embodiments, the importance score may be considered when determining likelihood of attendance. In some instances, an importance score may reflect a degree that the invitee would attend a proposed meeting. In particular, a meeting organizer may be more willing to schedule a meeting to accommodate invitees or are likely to attend, vs. trying to accommodate invitees who are not going to attend anyway. Thus, in an embodiment, user activity in relation to historical meetings (meeting history 256 and meeting patterns 237) may be analyzed to determine a level of involvement, participation, or attendance frequency for recurring meetings, for a user, which may indicate a level of importance. For example, user activity detected on a user device indicating that a user is browsing vacation-planning websites during a meeting about company financial reports may indicate information about the importance of the meeting to the user, and may in some embodiments be used to determine a user's likelihood of attending a future meeting or a degree to which a future meeting should be scheduled to accommodate this user's schedule, if there is a conflict. (In other words, it may be worth scheduling a future meeting at a time when this particular user is unable to attend, in order to accommodate other users who are more likely to participate or contribute to the meeting, but who would not be able to attend if the future meeting were scheduled to accommodate the particular user.)

Meeting features optimizer 268 is generally responsible for determining optimal meeting features for the proposed meeting(s) based on the goals or concerns of the meeting organizer. For instance, the meeting organizer could be interested in scheduling a meeting to in a manner that maximizes the likelihood of attendance by all invitees. Alternatively, a meeting organizer may wish to maximize attendance by invitees with higher importance scores, or to prioritize the meeting schedule to accommodate those invitees having a higher importance score than other invitees.

In some embodiments, meeting features optimizer 268 receives features for a proposed meeting, and may also receive importance scores, attendance models, and/or determinations of likelihood of attendance for the meeting invitees. Meeting features optimizer 268 may also access external information such as parameters or conditions used for scheduling meetings; for instance, information indicating available meeting locations (which may also include the times that those locations are available and/or meeting resources available at those locations, such as presentation equipment, coffee or food, seating capacity, etc.). In one embodiment, external parameters include geographical or physical location information about meeting locations and the locations of meeting invitees, which may be used to determine a location that minimizes travel distance or time for meeting invitees. The location information may be regional, national, or local; for instance, a geographical area comprising a city, a campus, or a building. Using such external information, the features for the proposed meeting, and information about the invitees, such as importance scores, attendance models, and/or determinations of likelihood of attendance, an embodiment of meeting features optimizer 268 determines a set of optimal meeting features, which as described above, may include optimal location(s) and/or venue(s), time(s), date(s), duration, as well as other features, in some cases, such as invitees or meeting subject(s), to achieve the goals of the organizer (such as maximizing attendance of meeting attendees with the highest importance scores).

In some aspects, maximizing attendance of meeting attendees with the highest importance scores may be facilitated, for example, by determining optimal meeting features that reconcile meeting importance scores and likelihood of attendance to establish optimal conditions for a meeting. Accordingly, in such embodiments, meeting features optimizer 268 may identify meeting features that result in both a high acceptance rate and a high likelihood of the most important meeting invitees accepting the invitation. In some embodiments, meeting features optimizer 268 uses optimization logic, which may include rules, conditions, associations, classification models, or other criteria to determine optimal features given the meeting organizer's goals or concerns. For example, in one embodiment, the optimization logic may include machine learning and/or statistical classification processes, for instance high-dimensional clustering. Moreover, in some embodiments, meeting features optimizer 268 may invoke repeatedly likelihood of attendance determiner 266 to determine a range of likelihood of attendance given various values to meeting features. Alternatively, meeting features optimizer 268 may operate in conjunction with likelihood of attendance determiner 266 to effectively determine or calculate likelihood of attendance as a function of meeting features. In this way, meeting features can be optimized or solved such that the desired attendance goals are achieved.

Meeting features recommender 270 is generally responsible for providing the optimal meeting features determined by meeting features optimizer 268 to a meeting organizer. As described previously, the optimal features may be provided as a recommendation, such as a draft meeting invite communication, may be provided by automatically scheduling the meeting or automatically generating and sending a meeting request communication according to the optimal meeting features. (For instance, a meeting organizer could simply enter the features for a proposed meeting, and click a button “optimize meeting details” which automatically determines optimal meeting features.) In one embodiment, the meeting organizer may be provided with visual indications, within a meeting planning user interface, of suggested optimal meeting features and/or related information, such as importance scores or likelihood of attendance corresponding to the invitees. In one embodiment, meeting features recommender 270 may suggest and/or display selectable meeting options to the meeting organizer. The selectable meeting options may include features for one or more meetings, associated with the meeting organizer, that have been identified by meeting features optimizer 268. Optimal features may be automatically populated in the selectable meeting options.

In some embodiments, more than one feature may be determined as optimal or otherwise compatible with a meeting organizers goal; for instance more than one date or available location may be likely to result in attendance by more important invitees. In some instances, meeting features recommender 270 may provide all of the optimal features so that a meeting organizer can choose which features to apply to the proposed meeting (for example, the meeting organizer may use a meeting planner user interface provided via presentation component 220 and user-data collection component 210). In other embodiments, meeting features recommender 270 may provide those features that are closest to the original features proposed by the meeting organizer. For instance, if the meeting was originally proposed for Tuesday and meeting manager 260 determines that important invitees cannot attend Tuesday, but meeting features optimizer 268 determines that important Wednesday and Friday are optimal meeting dates, then meeting features recommender 270 may recommend Wednesday, since it is closer to the originally proposed feature date (Tuesday.)

Meeting features recommender 270 provides optimal meeting features to a presentation component 220, and/or other components of system 200. In some embodiments, the optimal meeting features may be provided to one or more consumer applications or services (not shown) that may use the features for generating a meeting invite, for scheduling, or for planning. Examples of such consumer applications or services include apps such as scheduling or planning apps. In some embodiments, the optimal meeting features and related meeting information may be provided as an API to third party applications or services.

As described above, in some embodiments, a recommendation may be provided to the meeting organizer indicating optimal meeting features for a proposed meeting event. In some aspects, the meeting attendee importance score and any other meeting data generated using components of system may be displayed on a user device associate with the meeting organizer via the presentation component 220 and the network 110. In some embodiments, the meeting organizer may also see data indicating a likelihood of attendance for the invitees, including those invitees having a higher importance score. In this way, meeting organizers may evaluate meeting attendee importance scores of conflicting meetings before sending an invitation. This allows the meeting organizer to identify individual meeting invitees who have conflicting meetings and evaluate the relative meeting attendee importance score and/or likelihood of attendance of each meeting. Further, in evaluating conflicting meetings, the meeting attendee importance scores enable the meeting organizer to determine how the meeting they are currently generating compares to other meetings that have been proposed or scheduled for the same time. The meeting organizer may then make a determination as to whether important invitees are more likely to attend a proposed meeting they are generating than a competing meeting. Depending on the meeting attendee importance score of the conflicting meeting(s) and/or likelihood of attendance for invitees, the meeting organizer may choose different meeting features for the proposed meeting, such as a different time or location, or the organizer may choose not to adjust the meeting features.

In some embodiments, information from meeting attendance models for meeting invitees may be displayed or made accessible via meeting manager and presentation component 220. Similarly, a user-invitee may be able to access and aspects of view his or her meeting attendance model. This may provide an opportunity for the user to see patterns and trends that may be reflected in their meeting attendance model. Further, in some instances, the meeting attendance models of other user profiles and/or an aggregated meeting attendance model (which may remove identifying information, in some instances) may also be generated for display. In such embodiments, the user interface may enable a comparison to be presented of a given user meeting attendance model verses the other users attendance models and/or the aggregated meeting attendance model. Still further, in some aspects, when a proposed meeting is communicated to an invitee user, it may include (or make accessible, such as via a link) the meeting attendance model for that particular invitee user. The proposed meeting may also include the aggregated meeting attendance model for all invitee user profiles associated with the proposed meeting and likelihood of attendance associated therewith. This may be useful, for example, when another meeting event conflicts with the proposed meeting.

Additionally, the user may receive an annotation that indicates the information that impacted the user's meeting attendance model for the proposed meeting. The annotation may also provide a suggestion relating to a pattern within the meeting attendance model and a suggested response for the proposed meeting. For example, if an annotation contains an indication that the user has a pattern associated with meeting events on Tuesdays at 3:00 PM (for example, the user never attends meetings at this time), the pattern and an annotation may be presented so that the user may evaluate whether this day and time actually limits their ability to attend the meeting or to reschedule other obligations. In some aspects, the likelihood of attendance determined by likelihood of attendance determiner 266 may also be presented with the proposed meeting invite.

Continuing with FIG. 2, an example user profile 250 is shown and is generally responsible for storing user-related information, including meeting event information, for a particular user. For example, meeting event data elements collected by the user -user-data collection component 210 may be stored in the user profile 250 in association with a particular user profile. Additionally, data determined from user activity monitor 280, meeting event pattern inference engine 230, and/or meeting attendance model generator 240 may be stored in user profile 250. The user profile 250 may also operate to provide this stored information to other components of the meeting management system 200 for a respective user.

Example user profile 250 includes user devices 251, meeting history 256, meeting patterns 237, and meeting attendance model 252, each of which are previously described herein. In addition to storing a meeting attendance model for a particular user, some embodiments of meeting attendance model 252 may reflect meeting patterns associated with the user. Meeting attendance model 252 may also include one or more response models, as detailed hereinabove. User account(s) and activity data 253 generally includes user data collected from user-data collection component 210 (which in some cases may include crowd-sourced data that is relevant to the particular user) or other semantic knowledge about the user. In particular, user account(s) and activity data 253 can include data regarding user emails, texts, instant messages, calls, and other communications; social network accounts and data, such as news feeds; online activity; calendars, appointments, or other user data that may have relevance for determining meeting patterns, attendance models, or related meeting information; user availability; and importance, urgency, or notification logic. Embodiments of user account(s) and activity data 253 may store information across one or more databases, knowledge graphs, or data structures. In one example, user account(s) and activity data 253 may be determined using calendar information from one or more user calendars, such as office calendars, personal calendars, social media calendars, or even calendars from family members or friends of the user, in some instances. Moreover, some embodiments of the invention may construct a complementary or shadow calendar for a user, as described herein, which may be stored in user account(s) and activity data 253.

User preferences 254 generally includes user settings regarding meeting features, user-availability related settings, user preferences for meeting times, locations, or other features, thresholds (such as importance score thresholds) and/or notification preferences, as described herein. For example, a user may configure a setting to adjust their attendance model, such as specifying likely attendance in the user attendance model whenever a certain invitee (such as a boss or company executive) is on the meeting. A user may also specify preferred locations and times, which may be reflected in the user' attendance model and may be taken into consideration by meeting features recommender 270 and/or a meeting organizer.

Presentation component 220 generally operates to render various user interfaces or otherwise provide information generated by the meeting management system 200 and the components thereof in a format that can be displayed on a user device. By way of example, the presentation component 220 may render a meeting management service interface (such as a meeting planner) for receiving proposed meeting invitation details and presenting additional meeting details generated by the meeting manager 260 (the additional meeting details may be generated, for example, by meeting features recommender 270, discussed herein). In some aspects, the presentation component 220 may also render a meeting attendance model interface that allows user interaction with meeting attendance models.

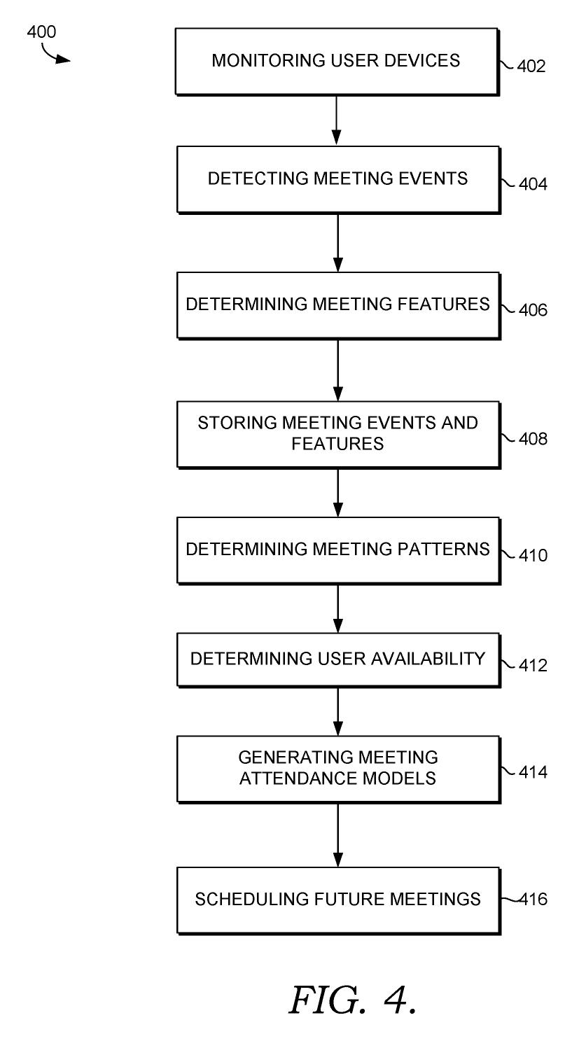

Turning now to FIG. 4, a flow diagram is provided that illustrates a method 400 for generating meeting attendance models to facilitate scheduling future meetings. Initially, as shown at block 402, the method includes monitoring, for example using the user activity monitor 280, a set of user devices associated with a user to detect a meeting event. Further, as shown at block 404, the method may include, upon detecting a meeting event, determining a set of meeting features associated with the meeting event, the set of meeting features determined based at least in part on sensor data. In one aspect, the method comprises determining, by the one or more processors, semantic information including contextual meeting event features. In additional aspects, the set of meeting features associated with the meeting event comprises the semantic information. In additional aspects, the meeting features include one or more of a meeting location; a number of meeting invitees; a meeting day and time; and a meeting organizer.

In some aspects, as shown at block 406, the method comprises storing a record of the meeting event and associated meeting features in an activity event data store that comprises records of a plurality of meeting events. At block 408, the method may include using the meeting pattern inference engine to determine a meeting pattern based on an analysis of the plurality of meeting events to determine a set of meeting events having similar meeting features. As shown at block 410, the method may include determining user availability for attending a future meeting over a range of time. In additional aspects, determining user availability accounts for near-real-time data from the user activity monitor. In additional aspects, the determined availability includes existing meeting detected by an existing meeting detection component. Additionally, in some aspects, as shown at block 412, the method may include generating a meeting attendance model for the user based at least on the determined meeting pattern and the determined user availability. Additionally, as shown at block 414, the method may comprise scheduling the future meeting based at least in part on the meeting attendance model.

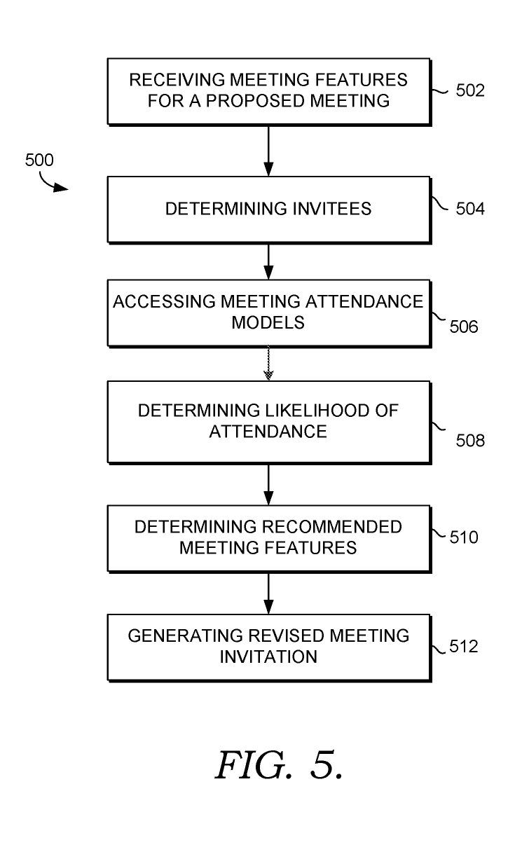

With reference to FIG. 5, a flow diagram is provided that illustrates a method 500 for determining optimal meeting features for proposed meetings. Initially, as shown at block 502, the method includes receiving a first set of meeting features for a proposed meeting. Further, as shown at block 504, the method includes, determining one or more invitees from the features. In some aspects, as shown at block 506, the method comprises accessing a meeting attendance model for at least one invitee of the one or more invitees.

At block 508, the method may include determining a likelihood of attendance for the at least one invitee. In one aspect, the likelihood of attendance for the at least one invitee accounts for user availability includes near-real-time data from the user activity monitor. In another aspect, user device location data the likelihood of attendance for the at least one invitee is determined using user device location data. In additional aspects, the likelihood of attendance for the at least one invitee is determined using existing meeting detected by an existing meeting detection component. Further, in some aspects, the method comprises determining, by the one or more processors, an importance score for the at least one invitee. In additional aspects, the importance score is a numeric value that reflects a degree of importance of the at least one invitee in relation to the proposed meeting.

As shown at block 510, determining a second set of meeting features optimized according to the likelihood of attendance for the at least one invitee. In additional aspects, the second set of meeting features is further determined according to the importance score for the at least one invitee. Additionally, in some aspects, as shown at block 512, the method may include generating a revised meeting invitation according to the second set of meeting features.

Accordingly, we have described various aspects of technology directed to systems and methods for providing improved meeting scheduling functionality, which may include meetings optimized for attendance by certain users, and/or determining meeting attendance models based on prior meeting events. It is understood that various features, sub-combinations, and modifications of the embodiments described herein are of utility and may be employed in other embodiments without reference to other features or sub-combinations. Moreover, the order and sequences of steps shown in the example methods 400 and 500 are not meant to limit the scope of the present invention in any way, and in fact, the steps may occur in a variety of different sequences within embodiments hereof. Such variations and combinations thereof are also contemplated to be within the scope of embodiments of the invention.

Having described various embodiments of the invention, an exemplary computing environment suitable for implementing embodiments of the invention is now described. With reference to FIG. 6, an exemplary computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. Exemplary presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Accordingly, in one aspect, an embodiment of the invention is directed to a computerized system comprising one or more sensors configured to provide sensor data. In one aspect, the system comprises a user activity monitor configured to identify and monitor a user device and user activity associated with the user device. In some aspects, the system includes a meeting pattern inference engine configured to determine a meeting pattern from a plurality of meeting events.

Further, in some aspects, the system comprises one or more processors; and one or more computer storage media storing computer-useable instructions that, when executed by the one or more processors, implement a method. In one aspect, the method comprises monitoring, using the user activity monitor, a set of user devices associated with a user to detect a meeting event. The method may also include, upon detecting a meeting event, determining a set of meeting features associated with the meeting event, the set of meeting features determined based at least in part on the sensor data. In one aspect, the method comprises determining, by the one or more processors, semantic information including contextual meeting event features. In additional aspects, the set of meeting features associated with the meeting event comprises the semantic information. Further, in some aspects, the method comprises storing a record of the meeting event and associated meeting features in an activity event data store that comprises records of a plurality of meeting events. In additional aspects, the meeting features include one or more of a meeting location; a number of meeting invitees; a meeting day and time; and a meeting organizer.

Additionally, the method may comprise using the meeting pattern inference engine to determine a meeting pattern based on an analysis of the plurality of meeting events to determine a set of meeting events having similar meeting features. Further, the method may also include determining user availability for attending a future meeting over a range of time. The method may also include generating a meeting attendance model for the user based at least on the determined meeting pattern and the determined user availability. In additional aspects, determining user availability accounts for near-real-time data from the user activity monitor. In additional aspects, the determined availability includes existing meeting detected by an existing meeting detection component. Further, in some aspects, the method comprises scheduling the future meeting based at least in part on the meeting attendance model.

In another aspect, an embodiment of the invention is directed to a computerized system comprising one or more sensors configured to provide sensor data. In one aspect, the system comprises a meeting pattern inference engine configured to determine a meeting pattern from a plurality of meeting events.

In some aspects, the system includes a meeting manager configured to determine optimal meeting features for future meetings. Further, in some aspects, the system comprises one or more processors and one or more computer storage media storing computer-useable instructions that, when executed by the one or more processors, implement a method. In one aspect, the method comprises receiving a first set of meeting features for a proposed meeting. The method may also include determining one or more invitees from the features. In one aspect, the method comprises accessing a meeting attendance model for at least one invitee of the one or more invitees.

Further, in some aspects, the method comprises determining a likelihood of attendance for the at least one invitee. In additional aspects, the likelihood of attendance for the at least one invitee accounts for user availability includes near-real-time data from the user activity monitor. In additional aspects, user device location data the likelihood of attendance for the at least one invitee is determined using user device location data. In additional aspects, the likelihood of attendance for the at least one invitee is determined using existing meeting detected by an existing meeting detection component.

In additional aspects, the method comprises determining, by the one or more processors, an importance score for the at least one invitee. In additional aspects, the importance score is a numeric value that reflects a degree of importance of the at least one invitee in relation to the proposed meeting.

Additionally, the method may comprise determining a second set of meeting features optimized according to the likelihood of attendance for the at least one invitee. In additional aspects, the second set of meeting features is further determined according to the importance score for the at least one invitee. Further, the method may also include generating a revised meeting invitation according to the second set of meeting features.

Another embodiment of the invention is directed to a computerized method. The method includes monitoring a set of user devices associated with one or more users to detect a meeting event. In one aspect, the method comprises, upon detecting a meeting event, determining a set of meeting features associated with the meeting event, the set of meeting features determined based at least in part on the sensor data. In one aspect, the method comprises determining semantic information including contextual meeting event features. In additional aspects, determining user availability accounts for near-real-time data.

The method may also include storing a record of the meeting event and associated meeting features in an activity event data store that comprises records of a plurality of meeting events. Further, in some aspects, the method comprises using the meeting pattern inference engine to determine a meeting pattern based on an analysis of the plurality of meeting events to determine a set of meeting events having similar meeting features.

Additionally, the method may comprise determining an availability of the one or more users for attending a future meeting over a range of time. Further, the method may also include generating a meeting attendance model for the one or more users based at least on the determined meeting pattern and the determined one or more users availability.

The method may also include receiving a first set of meeting features for a proposed meeting and determining one or more invitees from the features. Further, in some aspects, the method comprises accessing a meeting attendance model for at least one invitee of the one or more invitees. Further, the method may also include determining a likelihood of attendance for the at least one invitee. In one aspect, the method comprises determining, by the one or more processors, an importance score for the at least one invitee. In additional aspects, the second set of meeting features is further determined according to the importance score for the at least one invitee.

The method may also include determining a second set of meeting features optimized according to the likelihood of attendance for the at least one invitee. Additionally, the method may comprise generating a revised meeting invitation according to the second set of meeting features. In additional aspects, the second set of meeting features comprise one or more of: recommended meeting invitees; recommended meeting locations; a recommended meeting date and time; a recommended meeting subject; and a recommended meeting duration.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility, may be employed without reference to other features and sub-combinations, and are contemplated within the scope of the claims.

What is claimed is:

1. A computerized system comprising:
one or more sensors configured to provide sensor data;
one or more processors; and
one or more computer storage media storing computer-useable instructions that, when executed by the one or more processors, implement a method comprising:
monitoring user activity from a set of user devices associated with a user to detect a meeting event;
upon detecting a meeting event, determining a set of meeting features associated with the meeting event, the set of meeting features determined based at least in part on the sensor data;
storing a record of the meeting event and associated meeting features in an activity event data store that comprises records of a plurality of meeting-event records;
determining a meeting pattern based on an analysis of the plurality of meeting-event records to determine a set of meeting events having similar meeting features;
determining user availability for attending a future meeting over a range of time;
generating a meeting attendance model for the user based at least on the determined meeting pattern and the determined user availability; and
scheduling the future meeting based at least in part on the meeting attendance model.

2. The system of claim 1, further comprising determining, by the one or more processors, semantic information including contextual meeting event features.

3. The system of claim 2, wherein the set of meeting features associated with the meeting event comprises the semantic information.

4. The system of claim 1, wherein determining user availability accounts for near-real-time data from the user activity monitor.

5. The system of claim 1, wherein the determined availability includes existing meeting detected by an existing meeting detection component.

6. The system of claim 1, wherein the meeting features include one or more of: a meeting location; a number of meeting invitees; a meeting day and time; and a meeting organizer.

7. A system comprising:
one or more sensors configured to provide sensor data;
one or more processors; and
one or more computer storage media storing computer-useable instructions that, when executed by the one or more processors, implement a method comprising:
determining a meeting pattern from a plurality of meeting events;
receiving a first set of meeting features for a proposed meeting;
determining one or more invitees from the features;
accessing a meeting attendance model for at least one invitee of the one or more invitees;
determining a likelihood of attendance for the at least one invitee;
determining a second set of meeting features optimized according to the likelihood of attendance for the at least one invitee; and
generating a revised meeting invitation according to the second set of meeting features.

8. The system of claim 7, further comprising determining, by the one or more processors, an importance score for the at least one invitee.

9. The system of claim 8, wherein the second set of meeting features is further determined according to the importance score for the at least one invitee.

10. The system of claim 8, wherein the importance score is a numeric value that reflects a degree of importance of the at least one invitee in relation to the proposed meeting.

11. The system of claim 7, wherein the likelihood of attendance for the at least one invitee accounts for user availability includes near-real-time data from the user activity monitor.

12. The system of claim 7, wherein user device location data the likelihood of attendance for the at least one invitee is determined using user device location data.

13. The system of claim 7, wherein the likelihood of attendance for the at least one invitee is determined using existing meeting detected by an existing meeting detection component.

14. The system of claim 7, wherein the second set of meeting features comprise one or more of: recommended meeting invitees; recommended meeting locations; a recommended meeting date and time; a recommended meeting subject; and a recommended meeting duration.

15. One or more computer storage devices storing computer-useable instructions that, when used by one or more computing devices, cause the one or more computing devices to perform a method for facilitating a proposed meeting event using data elements stored in data structures, the method comprising:
monitoring a set of user devices associated with one or more users to detect a meeting event;
upon detecting a meeting event, determining a set of meeting features associated with the meeting event, the set of meeting features determined based at least in part on the sensor data;
storing a record of the meeting event and associated meeting features in an activity event data store that comprises records of a plurality of meeting events;
using the meeting pattern inference engine to determine a meeting pattern based on an analysis of the plurality of meeting events to determine a set of meeting events having similar meeting features;
determining an availability of the one or more users for attending a future meeting over a range of time;
generating a meeting attendance model for the one or more users based at least on the determined meeting pattern and the determined one or more users availability;
receiving a first set of meeting features for a proposed meeting;
determining one or more invitees from the features;
accessing a meeting attendance model for at least one invitee of the one or more invitees;
determining a likelihood of attendance for the at least one invitee;
determining a second set of meeting features optimized according to the likelihood of attendance for the at least one invitee; and
generating a revised meeting invitation according to the second set of meeting features.

16. The method of claim 15, further comprising determining semantic information including contextual meeting event features.

17. The method of claim 15, wherein determining user availability accounts for near-real-time data.

18. The method of claim 15, further comprising determining, by the one or more processors, an importance score for the at least one invitee.

19. The method of claim 18, wherein the second set of meeting features is further determined according to the importance score for the at least one invitee.

20. The method of claim 15, wherein the second set of meeting features comprise one or more of: recommended meeting invitees; recommended meeting locations; a recommended meeting date and time; a recommended meeting subject; and a recommended meeting duration.
